(19) United States
(12) Patent Application Publication
(10) Pub. No.: US 2014/0314998 A1
(43) Pub. Date: Oct. 23, 2014

(54) POROUS MATERIAL FOR THERMAL AND/OR ELECTRICAL ISOLATION AND METHODS OF MANUFACTURE

(71) Applicant: BRIGHAM YOUNG UNIVERSITY, PROVO, UT (US)

(72) Inventors: Robert C. Davis, Provo, UT (US); Richard R. Vanfleet, Provo, UT (US); Jason Lund, Orem, UT (US); Brian D. Jensen, Orem, UT (US)

(73) Assignee: BRIGHAM YOUNG UNIVERSITY, PROVO, UT (US)

(21) Appl. No.: 14/256,460

(22) Filed: Apr. 18, 2014

Related U.S. Application Data
(60) Provisional application No. 61/854,198, filed on Apr. 18, 2013.

(51) Int. Cl. H01B 3/12; H01B 19/04

(52) U.S. Cl. CPC H01B 3/12; H01B 19/04
USPC 428/172; 428/312.6; 427/344; 427/264

(57) ABSTRACT

In a general aspect, an apparatus can include a substrate and a porous layer disposed on the substrate, the porous layer including a plurality of silica nanotubes. The silica nanotubes of the porous layer can be solid, partially hollow and/or hollow elongate silica structures.

### CROSS-REFERENCE TO RELATED APPLICATIONS

This application claims benefit under 35 U.S.C. §119 of U.S. Provisional Patent Application No. 61/854,198, filed on Apr. 18, 2013 and entitled “A Porous Material Based on Carbon Nanotubes for Thermal and Electrical Isolation”, the disclosure of which is incorporated by reference herein in its entirety.

### TECHNICAL FIELD

This description relates to materials that may be used for thermal and/or electrical isolation, such as in micro-fabrication processes. In particular, the description relates to porous materials with low thermal and electrical conductivity and methods for forming isolation layers using such porous materials.

### BACKGROUND

Micro-fabrication processes, such as processes used to produce micro-machines, micro-fluidic devices, semiconductor devices, and so forth, often makes use of layers that provide thermal and/or electrical isolation properties. Silica aerogels have been used to provide such thermal and electrical isolation layers. However, while silica aerogels provide good thermal and electrical isolation, it may be difficult to control the thickness and uniformity (e.g., surface smoothness) of layers formed using such silica aerogels. Accordingly, silica aerogels do not work well in implementations requiring precise thicknesses and/or uniformity, such as in micro-fabrication processes where further processing may be performed (after forming the isolation layer) to create additional structures on the isolation layer.

### SUMMARY

In a general aspect, an apparatus can include a substrate and a porous layer disposed on the substrate. The porous layer can include a plurality of silica nanotubes. The silica nanotubes of the porous layer can be solid, partially hollow and/or hollow elongate silica structures.

Implementations can include one or more of the following features. For example, a silica nanotube of the plurality of silica nanotubes can be substantially perpendicular to an upper surface of the substrate. Two adjacent silica nanotubes of the plurality of silica nanotubes can have a lateral spacing between 50 nm and 100 nm.

The apparatus can include a barrier layer disposed directly on the substrate and a catalyst layer disposed directly on the barrier layer. The barrier layer can limit diffusion of the catalyst layer into the substrate. The porous layer can be disposed directly on the catalyst layer. The barrier layer can include aluminum oxide. The catalyst layer can include iron and/or nickel.

The substrate can include one of a semiconductor substrate, a glass substrate, a metal substrate and a ceramic substrate. The porous layer can have a thickness of greater than or equal to 5 μm.

The apparatus can include a layer of carbon nanotubes disposed on the porous layer. The layer of carbon nanotubes can fill gaps between the plurality of silica nanotubes near an upper surface of the porous layer. The plurality of silica nanotubes can be a first plurality of silica nanotubes, and the apparatus can include a layer of silica nanotubes disposed on the porous layer, the layer of silica nanotubes including a second plurality of silica nanotubes and filling gaps between the first plurality of silica nanotubes.

The apparatus can include at least one micro-fluidic (micro-scale) channel disposed on the porous layer. The apparatus can include one of a temperature sensor and an infrared sensor disposed on the porous layer.

In another general aspect, a method can include forming a barrier layer on a substrate and forming a catalyst layer on the barrier layer. The catalyst layer can be configured to promote carbon nanotube growth. The barrier layer can be configured to limit diffusion of the catalyst layer into the substrate. The method can also include growing a plurality of carbon nanotubes on the catalyst layer and forming a conformal silica layer on the plurality of carbon nanotubes. The method can further include oxidizing the carbon nanotubes to define a plurality of silica nanotubes from the conformal silica layer, the plurality of silica nanotubes defining a porous silica layer. The silica nanotubes of the porous layer can be solid, partially hollow and/or hollow elongate silica structures.

Implementations can include one or more of the following features. For example, forming the conformal silica layer can include depositing a conformal layer of silica on the plurality of carbon nanotubes.

The method can include, prior to growing the plurality of carbon nanotubes, patterning the catalyst layer to define one or more silica nanotube regions. The method can include forming a layer of nanotubes on the porous silica layer, the layer of nanotubes filling gaps between the plurality of silica nanotubes near an upper surface of the porous silica layer. The layer of nanotubes can include one of a layer of carbon nanotubes and a layer of silica nanotubes. The method can include forming one of a micro-fluidic (micro-scale) channel, a temperature sensor and an infrared sensor on the porous silica layer (e.g., directly on the porous silica layer or on the layer of nanotubes).

In another general aspect, an apparatus can include a substrate and a porous silica layer disposed on the substrate. The porous silica layer can include a plurality of silica nanotubes that are substantially perpendicular to an upper surface of the substrate. The apparatus can also include a layer of nanotubes disposed on the porous silica layer. The layer of nanotubes can fill gaps between the plurality of silica nanotubes near an upper surface of the porous silica layer. The apparatus can also include at least one micro-fluidic channel disposed on the layer of nanotubes.

In an implementation, each silica nanotube of the plurality of silica nanotubes can include an elongate silica structure that is one of a solid silica structure, a hollow silica structure and a partially hollow silica structure.

### BRIEF DESCRIPTION OF THE DRAWINGS

FIGS. 1A-1C are cross-sectional diagrams illustrating apparatus including a porous silica nanotube layer, in accordance with various implementations.

FIG. 2 is a flowchart illustrating a method for producing an apparatus including a porous silica nanotube layer, in accordance with an implementation.

FIGS. 3A-3G are cross-sectional drawings illustrating a method for producing an apparatus including a porous silica nanotube layer, such as the method of FIG. 2.

FIG. 4 is a scanning electron microscope image showing a side view of carbon nanotubes, in accordance with an implementation.

FIG. 5 is a scanning electron microscope image showing a perspective view of a porous silica nanotube layer, in accordance with an implementation.

FIG. 6 is a scanning electron microscope image showing a close-up side view of a porous silica nanotube layer, in accordance with an implementation.

FIG. 7 is a scanning electron microscope image showing a perspective view of porous silica nanotube layer that is partially covered with a fill layer, in accordance with an implementation.

FIG. 8 is a scanning electron microscope image showing a perspective view of a porous silica nanotube layer covered with a fill layer, in accordance with an implementation.

Like reference symbols in the various drawings indicate like and/or similar elements.

### DETAILED DESCRIPTION

In the following description, various apparatus including porous silica nanotube (SNT) layers (films) and methods for producing such apparatus are described. Such SNT films may include a plurality of SNTs, where each of the SNTs is an elongated silica structure that may or may not be hollow (e.g., may be solid, hollow, partially hollow, and so forth). The methods described herein may be used in a number of micro-fabrication technologies (e.g., clean-room technologies), such as semiconductor processes, micro-machining and micro-mechanical processes, sensor manufacturing, and so forth, to produce layers (films) for thermal and electrical isolation, and/or for other uses. For example, apparatus including porous SNT films, such as those described herein, may be used to implement chemical sensors, thermal sensors, infrared sensors, microfluidic devices, gas chromatography applications, micro-filtration devices, integrated circuits and micro-biological devices (e.g., DNA separators, cell sorters, cells separators, and so forth), as well as other possible implementations.

Using the approaches described herein, porous SNT films may be produced with relatively precise thicknesses, porosity and surface uniformity (surface smoothness), while providing excellent thermal and/or electrical isolation properties that are comparable with, for example, the thermal and electrical isolation properties of silica aerogels, which may have a thermal conductivity on the order of 0.03 Watts/meter-Kelvin (W/m-k).

In an experimental implementation, a porous silica layer was formed on a silicon substrate using the approaches described herein. In the experimental implementation, the porous silica layer was sprayed with carbon nanotubes (CNTs), leaving a black surface for radiation absorption. For purposes of comparison and experimental control, CNTs were also sprayed onto a bare silicon substrate. Laser illumination was then used to heat the top surfaces of both samples.

The relative temperature difference between the top and bottom surfaces for each sample were determined using infrared (IR) thermography on the top surfaces and thermocouples on the bottom surfaces. Based on a comparison between the two sample types, the thermal conductivity of the porous silica layer was estimated to be 0.025 W/m-K, which is about 40 times lower than SiO₂, and is slightly lower than the thermal conductivity achievable by silica aerogels (e.g., 0.03 W/m-K) and is also approximately the thermal conductivity of air. A lower thermal conductivity (e.g., of approximately 0.01 W/m-K) could be achieved, for example, using such porous silica films in a vacuum, rather than in air.

In other implementations, other thermal conductivities can be achieved. For instance, by reducing the porosity of the silica layer (e.g., by depositing/forming a thicker layer of SiO₂), the thermal conductivity can be increased. Depending on the physical characteristics of a given porous silica film (e.g., the film's porosity) and/or its ambient environment (e.g., air or a vacuum), thermal conductivities in a range of 0.01-1.0 w/m-K can be achieved.

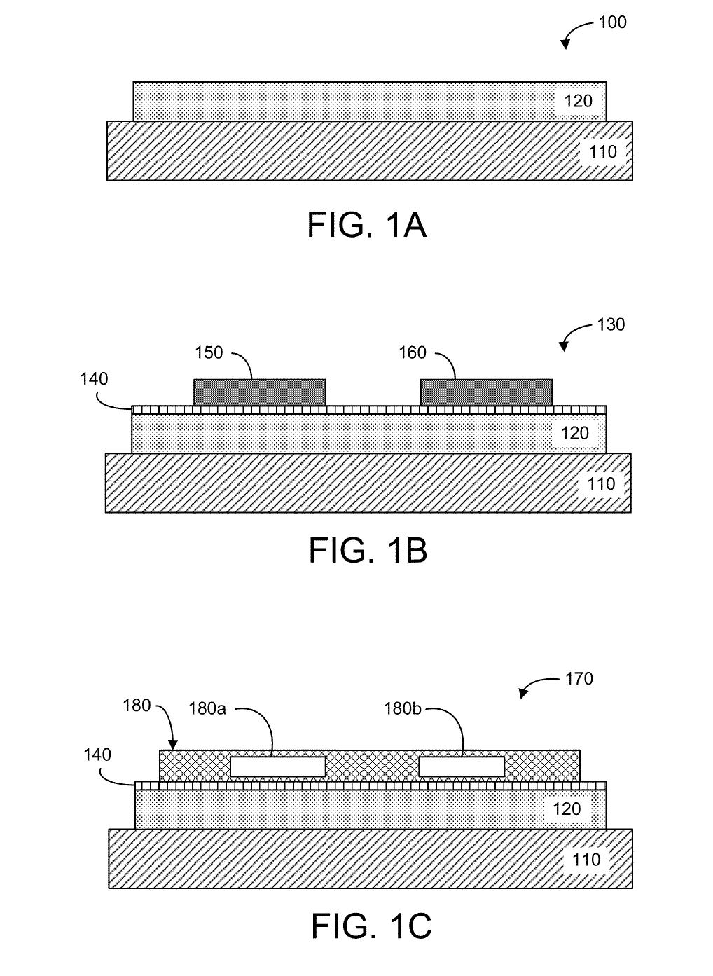

FIGS. 1A-1C are cross-sectional diagrams illustrating apparatus that include a porous SNT layer, in accordance with various implementations. Like elements in the example apparatus shown in FIGS. 1A-1C are referenced with like references numbers. In a given implementation, the specific arrangement and materials used in a particular apparatus, as well as the method of producing the apparatus, may vary based on the implementation. The apparatus shown in FIGS. 1A-1C are given by way of illustration, and any number of other apparatus that include and/or omit features of the apparatus illustrated herein are possible. In these implementations, illustration of the individual elements is for purposes of illustration, and those elements may not necessarily be shown to scale. Further, the specific physical configuration of each element may vary based on the particular implementation.

FIG. 1A is a cross-sectional diagram illustrating an apparatus 100, in accordance with an implementation. The apparatus 100 includes a substrate 110. The substrate 110 may be a semiconductor substrate (e.g., silicon (Si), silicon carbide, etc.), a metal substrate (e.g., stainless steel, nickel, etc.), a ceramic substrate (e.g., sapphire, carbon, etc.), glass, or may include a number of other appropriate substrate materials. The apparatus 100 also includes a porous SNT layer (a SNT layer) 120 that is disposed on the substrate 110. The SNT layer 120 may be formed using the approaches described herein.

The apparatus 100 (as well as the other apparatus described herein) can be formed as part of a micro-fabrication process, such as those described herein. The apparatus 100 may be used, for example, for micro-filtration, chemical sensing, or a number of other possible applications. In other embodiments, further processing may be performed to produce additional structures that are disposed on the SNT layer 120, such as in the apparatus shown in FIGS. 1A-1B, and described in further detail below.

FIG. 1B is a cross-sectional diagram illustrating an apparatus 130, in accordance with an implementation. As with the apparatus 100, the apparatus 130 includes a substrate 110 that may be implemented using a number of different materials, such as those described above. Further, as with the apparatus 100, the apparatus 130 also includes a SNT layer 120 that is disposed on the substrate 110, where the SNT layer 120 may be formed using the approaches described herein.

The apparatus 110 can also include a fill layer 140 that is disposed (e.g., directly disposed) on the SNT layer 120. The fill layer 140, which can be formed using the techniques described below, may fill space between adjacent SNTs of the SNT layer 140, as well as provide a relatively smooth surface (as compared to the upper surface of the SNT layer 120) for forming additional elements or components.

As shown in FIG. 1B, the apparatus 130 further includes a structure 150 and a structure 160 that are disposed on (e.g., directly disposed on) the fill layer 140. The structures 150, 160 can include a number of possible devices. For instance, the structures 150, 160 can include chemical sensors, thermal sensors, infrared sensors (e.g., sensor that implement pixels in a CCD imaging device) or integrated circuit components (e.g., metal lines for signal transfer), and so forth. In some implementations, only a single structure may be disposed on the fill layer 140, while in other implementation, additional structures may be disposed on the fill layer 140.

In still other implementations, the SNT layer 120 may be discontinuous (e.g., may include a discontinuity that is disposed between the structure 150 and the structure 160. Such discontinuities may be formed using one or more patterning operations (e.g., photolithography processes), such as those described herein. The SNT layer and fill layer 140 provide thermal and/or electrical isolation between the structures 150, 160 and the substrate 110, and also provide thermal and electrical isolation between the structure 150 and the structure 160.

FIG. 1C is a cross-sectional diagram illustrating an apparatus 170, in accordance with an implementation. As with the apparatus 130, the apparatus 170 includes a substrate 110 that may be implemented using a number of different materials, such as those described above. The apparatus 170 can also include a SNT layer 120 and a fill layer 140 that is disposed on (e.g., disposed directly on) the SNT layer 140, where the SNT layer 120 and the fill layer 140 can be formed using the approaches described herein.

As shown in FIG. 1C, the apparatus 170 can also include a structure 180 that defines a first micro-fluidic channel 180a and a micro-fluidic channel 180b. As illustrated in FIG. 1C, the structure 180 can be disposed on (e.g., directly disposed on) the fill layer 140. In an implementation, the micro-fluidic channels 180a, 180b may be micro-scale channels for carrying (transporting) liquids or gases.

The apparatus 170 can be used in number of applications, such as gas chromatography and micro-biological applications (e.g., DNA processing, cell sorting, cell separation, and so forth). In some implementations, the structure 180 can include a single micro-fluidic channel, while in other implementations; the structure 180 can include additional micro-fluidic channels. In the apparatus 170, the SNT layer 120 and/or the fill layer 140 can provide thermal isolation for the micro-fluidic channels 180a, 180b from the substrate 110, e.g., to prevent heat loss during their use in a given application.

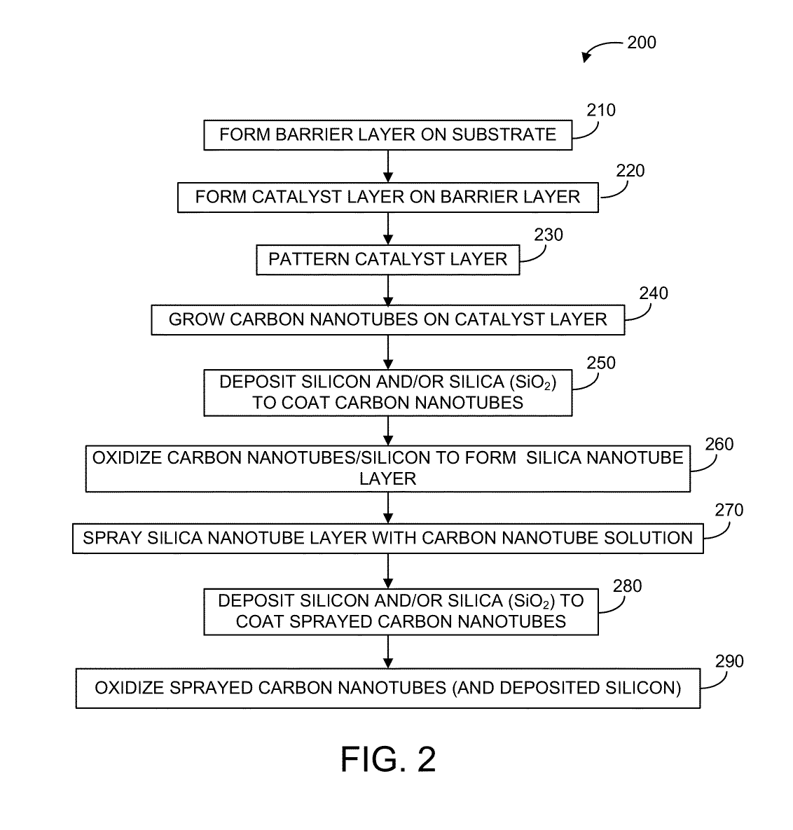

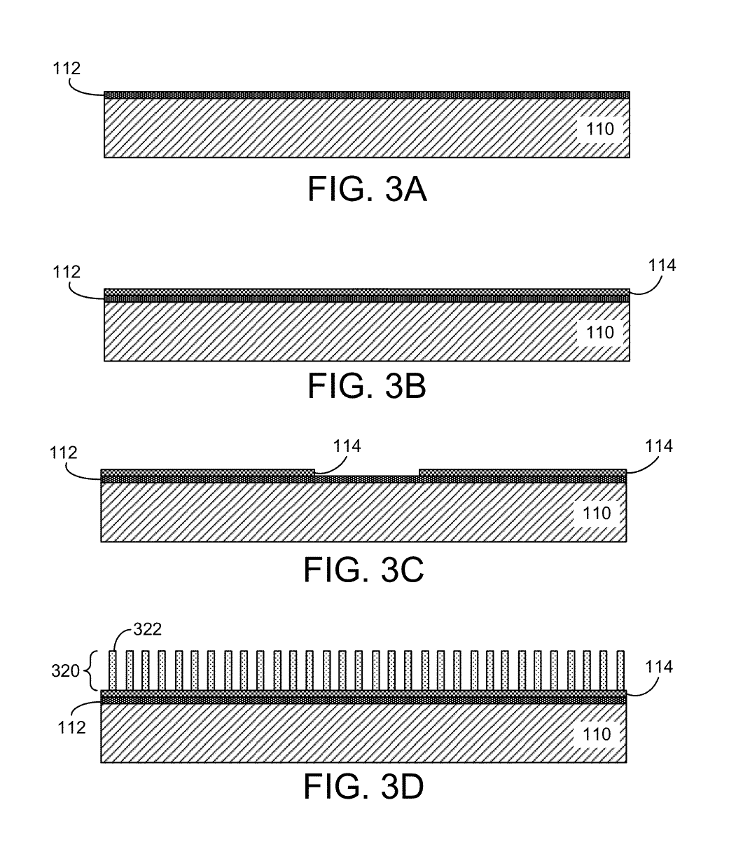

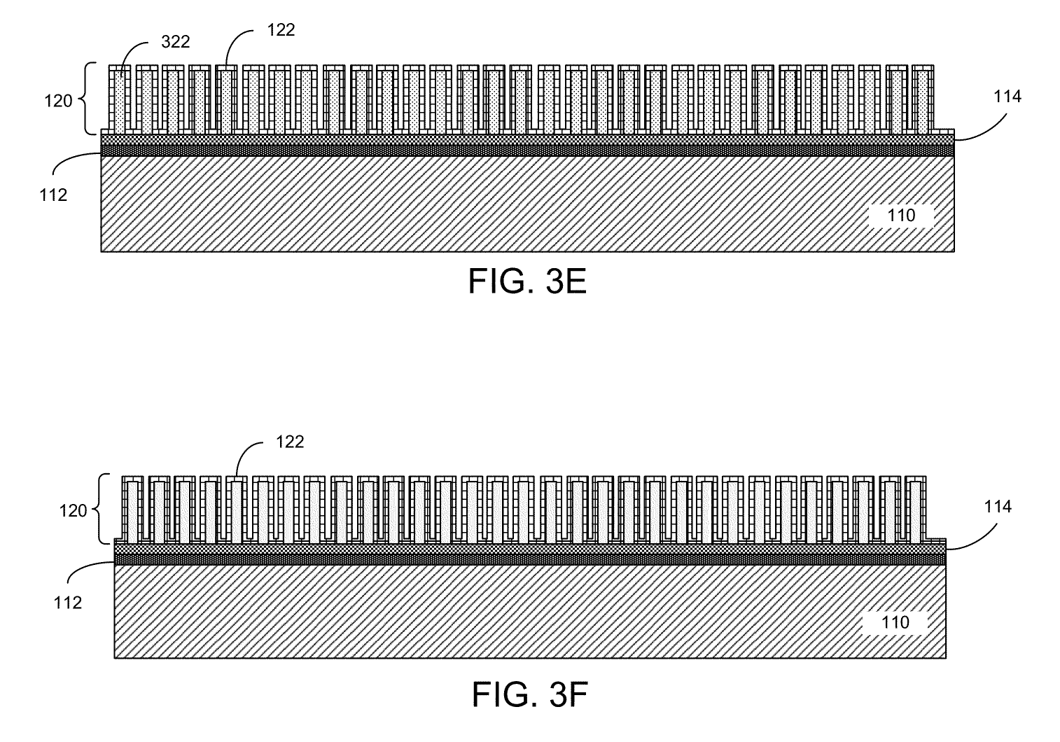

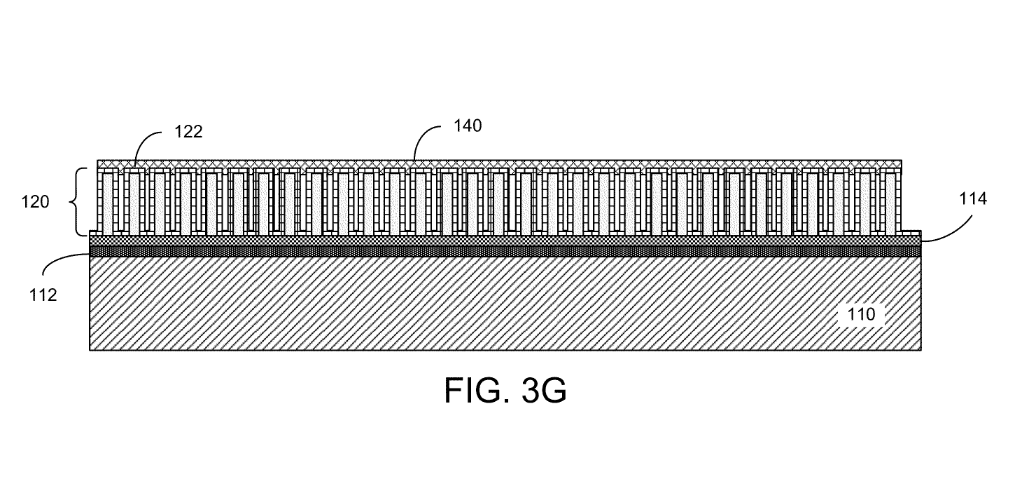

FIG. 2 is a flowchart illustrating a method 200 for producing an apparatus (such as the apparatus shown in FIGS. 1A-1C) including a porous SNT layer (such as the SNT 120), in accordance with an implementation. FIGS. 3A-3G are cross-sectional drawings illustrating the operations of the method 200. Accordingly, for purposes of illustration, the cross-sectional diagrams of FIG. 3A-3G will be discussed in conjunction with the method 200 illustrated in FIG. 2. It will be understood, however, that devices with other configurations and arrangements can be produced using the method 200. Further, in some implementations, some of the operations of the method 200 may be eliminated. In still other implementations, the method 200 may include additional operations, such as forming additional structures on the SNT layer 120 and/or the fill layer 140.

At block 210, the method 200 includes forming a barrier layer on (e.g., directly on) a substrate, an example of which is illustrated in FIG. 3A. As shown in FIG. 3A, a barrier layer 112 (which may also be referred to as a diffusion barrier or a diffusion barrier layer) can be formed on the substrate 110. As described herein, the substrate may include a number of materials, such as a metal, a semiconductor material, a ceramic material, and so forth. The barrier layer 112 prevents the diffusion of CNT catalyst ions (from a catalyst layer 114) into the substrate 110 during subsequent high-temperature processing.

In an implementation, the barrier layer 112 may include an aluminum oxide layer that can have a thickness in the range of 20-50 nm. In other implementations, the barrier layer 112 can have other thicknesses. In apparatus where the barrier layer 112 includes aluminum oxide, the barrier layer 112 can be formed using evaporation and/or sputtering. In other implementations, a spin on film that is cross-linked to form an aluminum oxide layer may be used to implement the barrier layer 112. In other implementations, other techniques for forming the barrier layer 112 may be used and will depend, at least, on the material (or materials) included in the barrier layer 112.

At block 220, the method 200 includes forming a catalyst layer 114 on (e.g., directly on) the barrier layer 112, such as is shown in FIG. 3B. The catalyst layer 114 can include a material (or materials) that promotes (catalyzes) CNT growth. For example, the catalyst layer 114 can include a layer of iron that is formed using thermal evaporation. In such implementations, the catalyst layer 114 (iron layer) may have a thickness in the range of 1.5-10 nm, for example. In other embodiments, the catalyst layer 114 may have other thicknesses and/or include other materials, such as nickel, for example, though a number of other materials may be used.

At block 230, the method includes patterning the catalyst layer 114, such as is illustrated in FIG. 3C. Patterning of the catalyst layer 114 can be done using one or more photolithography processes. For instance, the catalyst layer 114 can be patterned using a lift-off process, where a photoresist layer is formed on (e.g., directly on) the barrier layer 112 and then exposed with a desired pattern for the catalyst layer 114. The catalyst layer 114 can then be deposited and the exposed photoresist (or unexposed photoresist for negative resist types) can be removed using a photoresist etch, which will cause portions of the catalyst layer 114 that are disposed on the removed photoresist to be lifted off (removed).

In such implementations, formation of the nanotube layers (the CNT layer and the SNT layer) would be confined to those areas where the catalyst layer 114 remains after the patterning step of block 230. For purposes of illustration, the remaining operations of the method 200 (of blocks 240-290) are illustrated (in FIGS. 3D-3G) with the catalyst layer 114 being a continuous, un-patterned layer. In other implementations, the operations of block 240-290 can be performed on a patterned catalyst layer 114, such as the catalyst layer 114 shown in FIG. 3C. In such implementations, the SNT layer 120 would be formed on the areas of the apparatus where the catalyst layer is present. In other implementations, the catalyst layer 114 can be patterned by using one or more photoresist and etch processes that are performed after depositing (growing) the catalyst layer 114 to remove unwanted portions of the catalyst layer 114 for the particular implementation. In still other implementations, the CNT layer and/or the SNT layer can be patterned using photolithography and/or etch processes that are performed after nanotube formation.

At block 240, the method 200 includes growing a CNT layer 320 on the (patterned or un-patterned) catalyst layer 114, where the CNT layer 320 includes a plurality of CNTs 322. In an implementation, the CNT layer 320 may be formed in a furnace at a temperature in a range of 700-750 C. As discussed above, the barrier layer 112 can prevent diffusion of the catalyst layer 114 (e.g., catalyst ion) into the substrate 110 during CNT growth (e.g., high-temperature processing).

In an example implementation, the CNT growth process of block 240 may include flowing H₂ gas while the furnace temperature is increased to the desired growth temperature (e.g., 700-750 C). Flowing H₂ can reduce and/or prevent oxidation of the catalyst layer (e.g., iron oxide), which can prevent the formation of CNTs. When the furnace reaches the desired CNT growth temperature, an ethylene gas flow is added in the furnace environment, where ethylene acts as the precursor for CNT growth.

In such an approach, CNTs grow in what may be referred to as a “forest” of CNTs, where growth of the CNTs originates at sites of catalyst particles (e.g., iron or nickel particles on the surface) in the catalyst layer 114. The CNTs of the resulting CNT layer 320 (CNT forest) are substantially vertical, though frequent physical contact between the CNTs of the CNT forest can occur. Depending on the specific implementation (and catalyst used), the lateral spacing between CNTs in the CNT layer 320 can be substantially uniform and in a range of 50-100 nm, though smaller and/or larger lateral spacing between the CNTs of the CNT layer 320 are possible.

The height of the CNTs of the CNT layer 320 (thickness of the CNT layer 120 (CNT forest)) can be varied by varying the amount of time ethylene is flowed in the furnace during CNT growth at block 250. In example implementations, the height of the CNTs of the CNT layer 320 can be in a range of 5 μm to 1 mm, or greater. For instance, the height of the CNTs of the CNT layer 320 can be 1.5 mm or greater. As described herein, the CNT layer 320 can then be used a mold (template) for the formation of a porous SNT layer, such as the SNT layer 120 of FIGS. 1A-1C.

At block 250, the method 200 includes depositing a layer of silicon (Si) and/or silicon dioxide (SiO₂) on the CNT layer 320, as is shown in FIG. 3E. In other implementations, any of a wide variety of other materials, such as carbon, silicon nitride, metals or ceramics, as some examples, may be deposited on the CNT layer 320. The thermal and electrical properties of such layers would depend on the particular material (or materials) that are used.

For purposes of illustration in the following discussion, the deposited layer of block 250 will be referred to as a silica (SiO₂) layer. In approaches where Si is deposited, the Si can be subsequently oxidized to produce SiO₂ (silica), such as at block 260. The silica layer of block 250 defines the SNT layer 120. In example implementations, the silica layer is a thin layer (e.g., in a range of 10-20 nm) that coats the outer surface of the CNTs of the CNT layer 320 without filling in the lateral space between adjacent CNTs of the CNT layer 320. The silica layer can be deposited using a number of techniques, such as low-pressure chemical vapor deposition (LPCVD), atomic layer deposition (ALD) or plasma-enhanced chemical vapor deposition (PECVD), as well as other possible techniques, such as epitaxial growth.

At block 260, the method 200 includes oxidizing the CNTs of the CNT layer 320. The operation of block 260 can be performed in a furnace at a temperature of approximately 800 C in a dry air and/or O₂ environment. When oxidized, the CNTs of the CNT layer 320 are converted to CO₂ gas, which can be vented out of the furnace. Also, if Si is deposited at block 250, the Si can also be oxidized to form silica (SiO₂), which defines the SNTs of the SNT layer 120. After oxidization of the CNTs (and deposited Si), the silica layer defines a porous network (forest) of SNTs 122 (which define the SNT layer 120), as shown in FIG. 3F.

As shown in FIG. 3G, a fill layer 140, such as described herein, may be formed (disposed on) the SNT 120, where the layer 140 between adjacent SNTs 122 of the SNT layer 120 and also provides a uniform (smooth) upper surface for producing additional structures on the SNT layer 120. The fill layer 140 can be formed using a number of techniques. For instance, at block 270, the method 200 includes spraying a solution of CNTs dissolved in a solvent on the SNT layer 120 to form the fill layer 140. In certain implementations, additional structures (such as those described herein) may be formed on the fill layer as defined at block 270.

In other embodiments, the additional processing of blocks 280 and 290 of the method 200 can be performed to convert the CNTs of the fill layer 140 to SNTs. For instance, at block 280, Si and/or SiO₂ can be deposited (infiltrated) in/on the sprayed on CNTs of the fill layer 140 formed at block 270, such as using the silica (and/or Si) deposition approaches described herein. Then, at block 290, the sprayed on CNTs (and deposited Si) can be oxidized (such described above with respect to block 260) to produce a fill layer 140 that includes SNTs. As with the operation at block 260, the sprayed on CNTs can be converted to CO₂ gas and vented out of the furnace used to perform the oxidation. Subsequent processing can then be performed to produce additional structures, such as those described herein, that are disposed on the (SNT) fill layer 140.

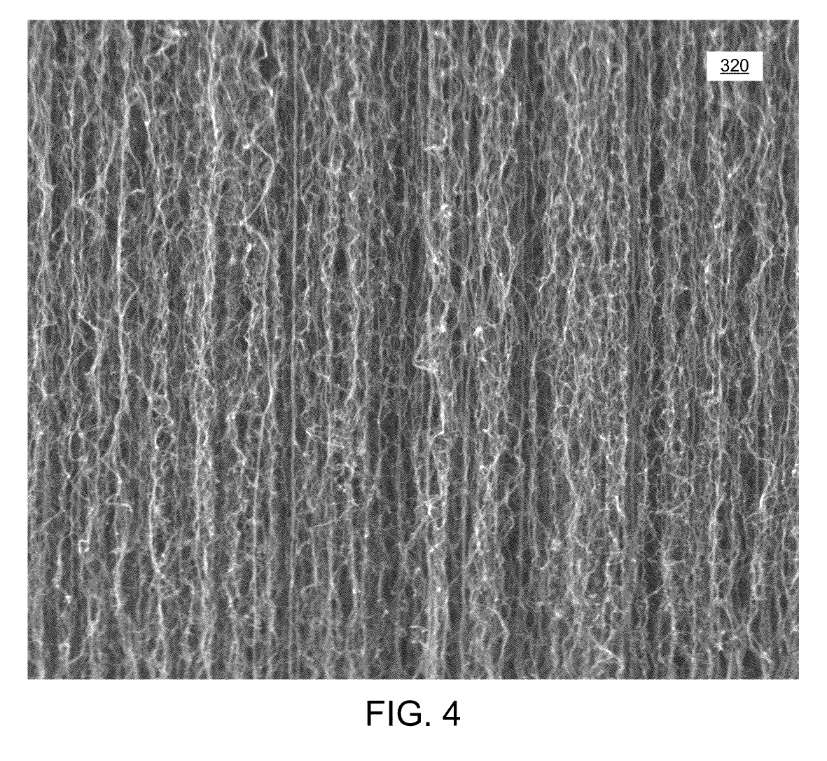

FIGS. 4-8 are scanning electron microscopy images showing various implementations of apparatus with porous nanotube layers, such as those described herein. As with the implementations described above, the apparatus shown in FIGS. 4-8 are illustrative. It will be understood that devices with other configurations and arrangements can be produced using the approaches described herein. For purposes of illustration, like reference numbers as those used in FIGS. 1A-1C and 3A-3G are used to reference like elements in FIGS. 4-8.

FIG. 4 is a scanning electron microscope (SEM) image showing a side view of a CNT layer 320 (which can also be referred to as a CNT forest or a CNT film), in accordance with an implementation. As described herein, the CNT layer 320 may include a plurality of CNTs that are spaced with substantially regular lateral spacing (e.g., between 50-100 nm). Each CNT of the CNT layer 320 may be substantially vertical (e.g., with respect to a surface of a substrate on which the CNT layer 320 is formed), though some contact between adjacent CNTs may be present. Further, the CNT layer 320 may be used as mold (or template) for the formation of a porous SNT layer, such as using the approaches described herein.

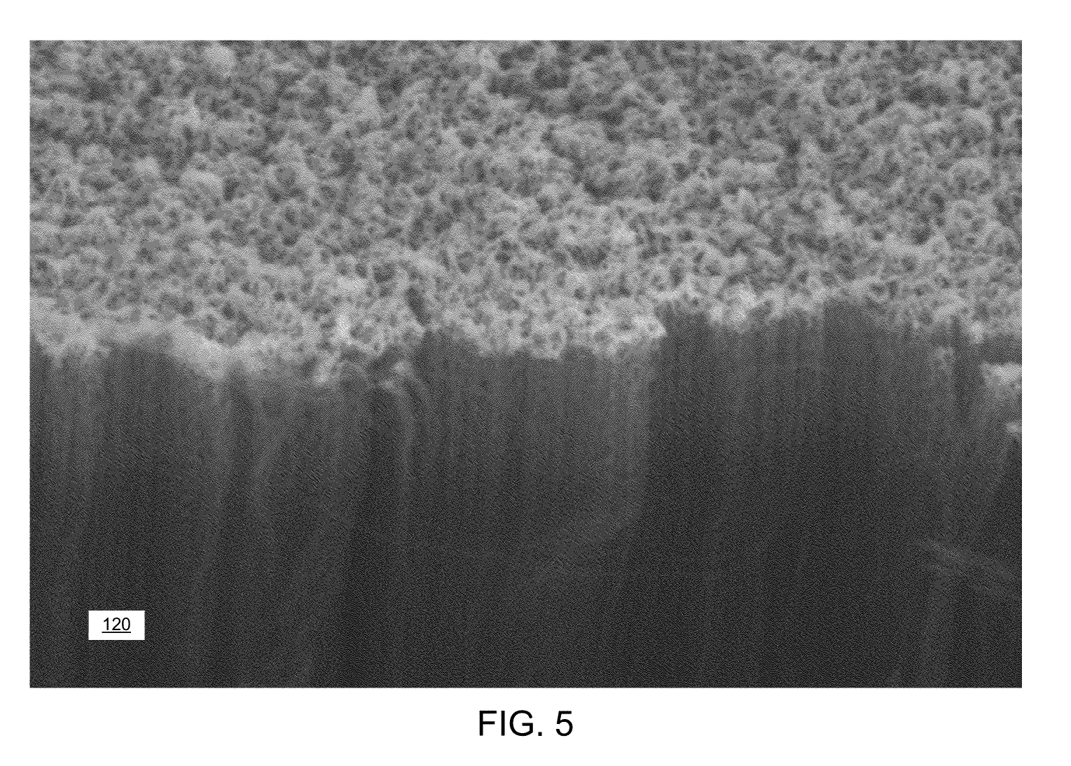

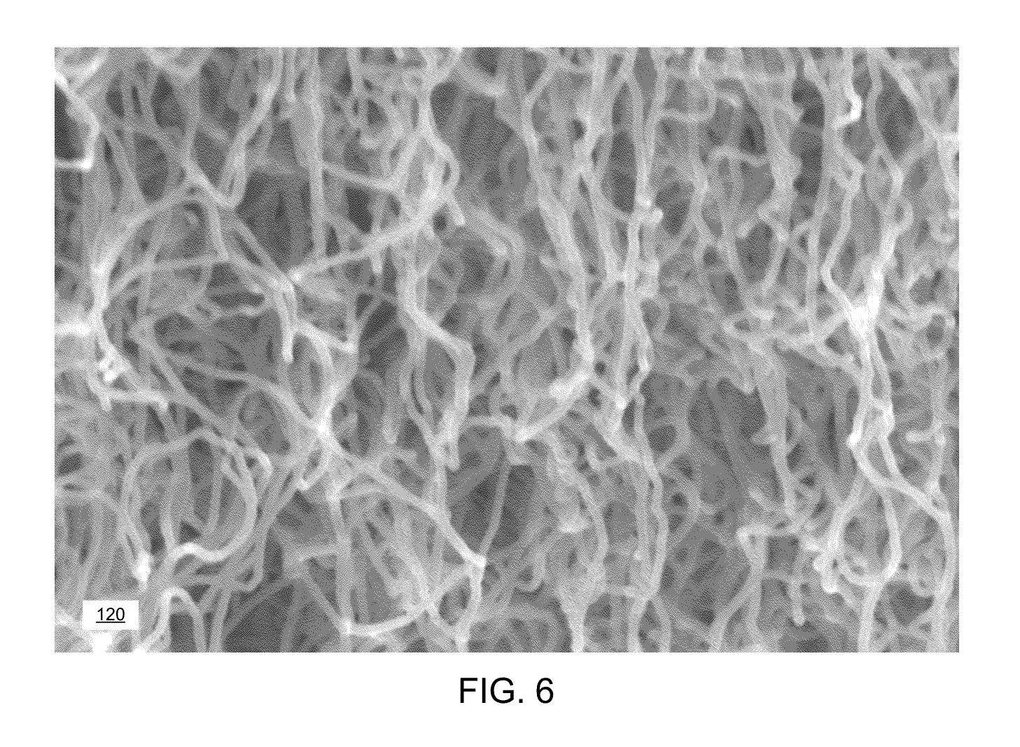

FIG. 5 is a (SEM) image showing a perspective view of a porous SNT layer 120 (which can also be referred to as a SNT forest or a SNT film), in accordance with an implementation. The porous SNT layer 120 can be produced using the techniques described herein, such as with respect to FIG. 2 and FIGS. 3A-3E, though other approaches are possible. For instance, the SNT layer 120 shown in FIG. 4 can be produced by depositing a thin layer of Si and/or SiO₂ on the CNT layer 320 shown in FIG. 5. The Si and/or SiO₂ covered CNT layer 320 (which can be disposed on a substrate) may then be placed in a furnace with a dry air and/or an O₂ environment (e.g., at 700-800 C), which will result in the CNTs of the CNT layer 320 being oxidized and converted to CO₂, which can be vented from the furnace. Additionally, if the CNT layer 320 is coated with Si, at least a portion of that Si would also be oxidized in the furnace to produce silica (SiO₂), and form the SNT layer 120. Alternatively, if the CNT layer 320 is coated with SiO₂, the SNTs of the SNT layer 120 can be defined by the deposited SiO₂ that remains after oxidation of the CNT layer 320. FIG. 6 is a scanning electron microscope image showing a close-up side view of the porous SNT layer 120 of FIG. 5.

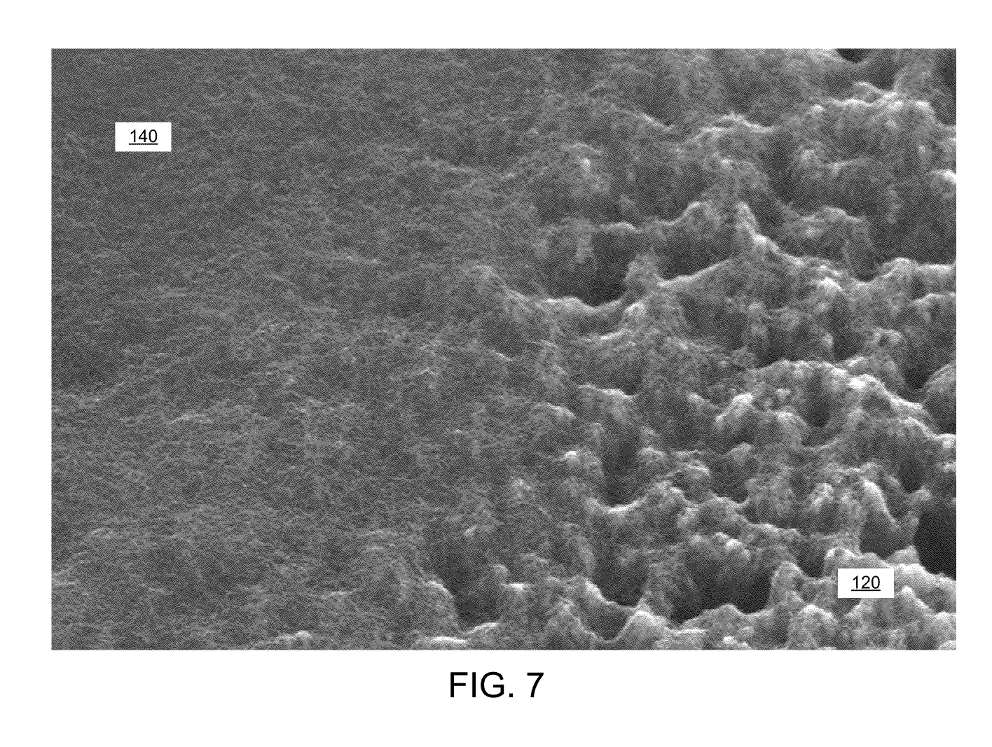

FIG. 7 is a SEM image showing a perspective view of a porous SNT layer 120 that is partially covered with a fill layer 140, in accordance with an implementation. In the example apparatus shown in FIG. 7, the fill layer 140 may include a CNT fill layer that is formed by spraying the SNT layer 120 with a solution of CNTs dissolved in a solvent, such as described herein. Of course, other approaches for forming the fill layer 140 can be used.

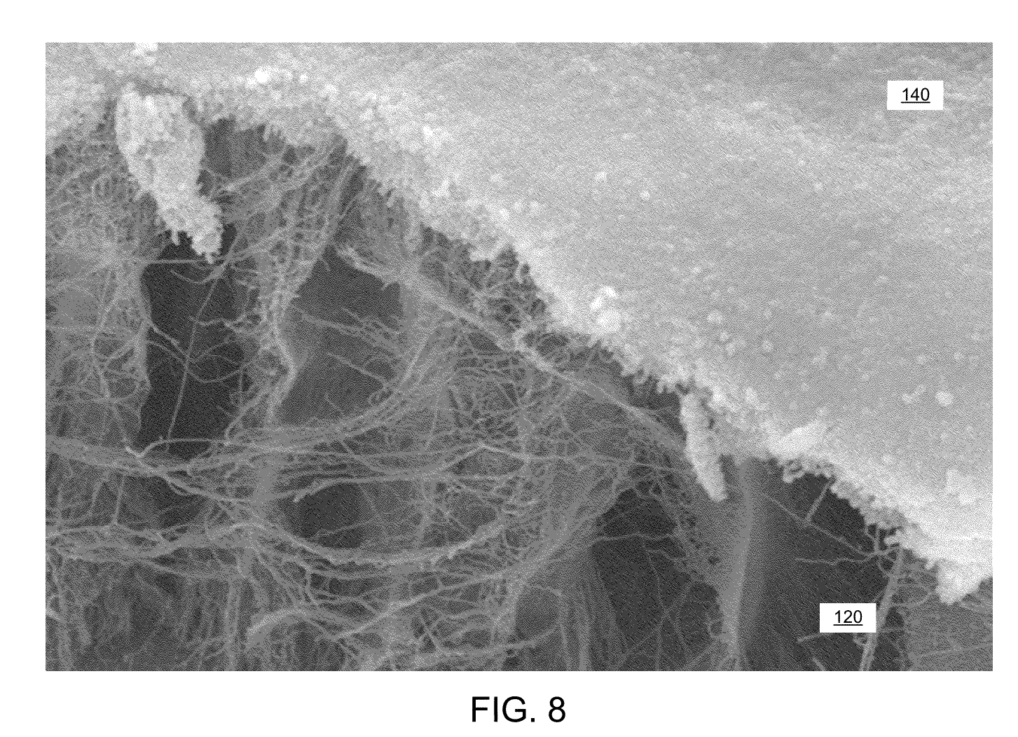

For instance, FIG. 8 is a SEM image showing a perspective view of a porous SNT layer 120 covered with another fill layer 140, in accordance with an implementation. In the example implementation shown in FIG. 8, the fill layer 140 may include a SNT fill layer that is formed by depositing Si and/or SiO₂ on the CNT fill layer shown in FIG. 7, and then oxidizing the sprayed on CNTs, such as previously described. In the image of FIG. 8, the side of the illustrated structure has been scraped to expose the underlying SNT layer 120, so as to illustrate the surface uniformity (surface smoothness) of the fill layer 140 (SNT fill layer). This scraping resulted in the damage to the SNTs of the SNT layer 120 that are visible in the image.

In the foregoing disclosure, it will be understood that when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What may be claimed is:

1. An apparatus comprising:
a substrate; and
a porous layer disposed on the substrate, the porous layer including a plurality of silica nanotubes.

2. The apparatus of claim 1, wherein a silica nanotube of the plurality of silica nanotubes is substantially perpendicular to an upper surface of the substrate.

3. The apparatus of claim 1, further comprising:
a barrier layer disposed directly on the substrate; and
a catalyst layer disposed directly on the barrier layer, the barrier layer limiting diffusion of the catalyst layer into the substrate, the porous layer being disposed directly on the catalyst layer.

4. The apparatus of claim 3, wherein the barrier layer includes aluminum oxide.

5. The apparatus of claim 3, wherein the catalyst layer includes one of iron and nickel.

6. The apparatus of claim 1, wherein the substrate includes one of a semiconductor substrate, a glass substrate, a metal substrate and a ceramic substrate.

7. The apparatus of claim 1, wherein the porous layer has a thickness of greater than or equal to 5 μm.

8. The apparatus of claim 1, further comprising a layer of carbon nanotubes disposed on the porous layer, the layer of carbon nanotubes filling gaps between the plurality of silica nanotubes near an upper surface of the porous layer.

9. The apparatus of claim 1, further comprising at least one micro-fluidic channel disposed on the porous layer.

10. The apparatus of claim 1, further comprising one of a temperature sensor and an infrared sensor disposed on the porous layer.

11. The apparatus of claim 1, wherein the plurality of silica nanotubes is a first plurality of silica nanotubes, the apparatus further comprising a layer of silica nanotubes disposed on the porous layer, the layer of silica nanotubes including a second plurality of silica nanotubes and filling gaps between the first plurality of silica nanotubes.

12. The apparatus of claim 1, wherein two adjacent silica nanotubes of the plurality of silica nanotubes have a lateral spacing between 50 nm and 100 nm.

13. A method comprising:
forming a barrier layer on a substrate;
forming a catalyst layer on the barrier layer, the catalyst layer being configured to promote carbon nanotube growth, the barrier layer being configured to limit diffusion of the catalyst layer into the substrate;
growing a plurality of carbon nanotubes on the catalyst layer;
forming a conformal silica layer on the plurality of carbon nanotubes; and
oxidizing the carbon nanotubes to define a plurality of silica nanotubes from the conformal silica layer, the plurality of silica nanotubes defining a porous silica layer.

14. The method of claim 13, wherein forming the conformal silica layer includes depositing a conformal layer of silica on the plurality of carbon nanotubes.

15. The method of claim 13, further comprising, prior to growing the plurality of carbon nanotubes, patterning the catalyst layer to define one or more silica nanotube regions.

16. The method of claim 13, further comprising forming a layer of nanotubes on the porous silica layer the layer of nanotubes filling gaps between the plurality of silica nanotubes near an upper surface of the porous silica layer.

17. The method of claim 16, wherein the layer of nanotubes includes one of a layer of carbon nanotubes and a layer of silica nanotubes.

18. The method of claim 13, further comprising forming one of a micro-fluidic channel, a temperature sensor and an infrared sensor on the porous silica layer.

19. An apparatus comprising:
a substrate;
a porous silica layer disposed on the substrate, the porous silica layer including a plurality of silica nanotubes that are substantially perpendicular to an upper surface of the substrate;
a layer of nanotubes disposed on the porous silica layer, the layer of nanotubes filling gaps between the plurality of silica nanotubes near an upper surface of the porous silica layer; and
at least one micro-fluidic channel disposed on the layer of nanotubes.

20. The apparatus of claim 19, wherein each silica nanotube of the plurality of silica nanotubes includes an elongate silica structure that is one of a solid silica structure, a hollow silica structure and a partially hollow silica structure.
